(19) United States
(12) Patent Application Publication
(10) Pub. No.: US 2026/0103615 A1
(43) Pub. Date: Apr. 16, 2026

(54) LASER MARKING COMPOSITION, RESIN FILM, AND LAYERED BODY

(71) Applicant: NIPPON CARBIDE INDUSTRIES CO., INC., Tokyo (JP)

(72) Inventor: Kyoko Shiomi, Namerikawa-shi, Toyama (JP)

(73) Assignee: NIPPON CARBIDE INDUSTRIES CO., INC., Tokyo (JP)

(21) Appl. No.: 19/115,346

(22) PCT Filed: Sep. 11, 2023
(86) PCT No.: PCT/JP2023/033048

§ 371 Date: Mar. 26, 2025

(30) Foreign Application Priority Data
Sep. 30, 2022 (JP) 2022-159099

(51) Int. Cl. C09D 11/50; C09D 7/61; C09D 7/65

(52) U.S. Cl. CPC C09D 11/50; C09D 7/61; C09D 7/65

(57) ABSTRACT

A laser marking composition includes at least one (meth)acrylic resin and a metal oxide containing at leas one metal selected from the group consisting of bismuth, antimony, molybdenum, copper, iron, nickel, chromium, zirconium, and neodymium, in which a proportion of structural units derived from an acrylic acid alkyl ester containing an alkyl group having 1 to 4 carbon atoms with respect to all structural units of the (meth)acrylic resin is 55% by mass or more.

### TECHNICAL FIELD

The present disclosure relates to a laser marking composition, a resin film, and a layered body.

### BACKGROUND ART

Various types of packaging for foods, pharmaceuticals, etc., as well as various types of components such as electronic parts, require printing of variable information for traceability, such as production lot numbers and production dates. As one method of marking for this purpose, a laser marking method may sometimes be employed. In particular, a color developing laser marking method that changes the color of a resin or a pigment by irradiation with a laser is used in a wide range of applications in recent years because it enables printing without generating odors or dust.

The following compositions are known as labels or inks for laser marking.

For example, Patent Document 1 discloses a pressure-sensitive adhesive that includes a pressure-sensitive adhesive resin (A) and a bismuth-based laser color developing agent (B), in which the pressure-sensitive adhesive is capable of forming a pressure-adhesive layer with suppressed coloration with favorable contrast after printing.

Patent Document 2 discloses an ink composition for laser marking, with sufficient laser printability (visibility), blocking resistance, adhesiveness, and lamination strength, the composition including a binder resin, a white pigment, and an organic solvent, in which the binder resin includes a polyurethane resin and a cellulose derivative, the cellulose derivative is a lower acyl group-substituted cellulose derivative and/or a lower alkyl group-substituted cellulose derivative, and the white pigment is titanium oxide having an average particle diameter of 0.26 μm or less.
Patent Document 1: Japanese Patent (JP-B) No. 6292429
Parent Document 2: Japanese Patent (JP-B) No. 7057236

### SUMMARY OF INVENTION

### Technical Problem

A resin composition capable of turning black upon laser irradiation typically utilizes a reduction reaction of an inorganic oxide by laser light. During reduction, heat is generated, which causes carbonization of the resin or generation of gas. Consequently, the carbonization of the resin can spread more than intended and cause blistering in the laminate, thus often resulting in reading errors when printing one-dimensional or two-dimensional codes.

For example, the pressure-sensitive adhesive using the bismuth-based laser color developing agent disclosed in Patent Document 1 may undergo deformation of the printing due to the heat generated during printing, which may make it difficult to read depending on the printed content.

Furthermore, in the ink composition for laser marking disclosed in Patent Document 2, because the urethane resin is easily carbonized, the resin around the inorganic oxide is also easily carbonized, which may make it difficult to read depending on the printed content. Moreover, (meth)acrylic copolymers mentioned in Comparative Examples of Patent Document 2 contain methacrylic resins as a main component, which may cause problems of generating gas and blistering easily during printing.

The present disclosure has been made in view of the aforementioned conventional circumstances, and the object thereof is to provide a laser marking composition capable of forming a resin film that exhibits excellent visibility and readability when printing one-dimensional or two-dimensional codes, while suppressing the generation of gas during printing, as well as to provide a resin film and a layered body using the laser marking composition.

### Solution to Problem

Specific means for achieving the above object are as follows:

<1> A laser marking composition including at least one (meth)acrylic resin and a metal oxide containing at least one metal selected from the group consisting of bismuth, antimony, molybdenum, copper, iron, nickel, chromium, zirconium, and neodymium,
in which a proportion of structural units derived from an acrylic acid alkyl ester containing an alkyl group having 1 to 4 carbon atoms with respect to all structural units of the (meth)acrylic resin is 55% by mass or more.

<2> The laser marking composition according to <1>, in which a total of proportions of structural units derived from methacrylic acid and structural units derived from a methacrylic acid alkyl ester with respect to all structural units of the (meth)acrylic resin is less than 45% by mass.

<3> The laser marking composition according to <1> or <2>, in which a total of proportions of structural units derived from ethyl acrylate, structural units derived from methyl acrylate, and structural units derived from 2-hydroxyethyl acrylate with respect to all structural units of the (meth)acrylic resin is 20% by mass or more.

<4> The laser marking composition according to any one of <1> to <3> in which the metal oxide includes a bismuth-containing compound.

<5> A resin film formed by using the laser marking composition according to any one of <1> to <4>.

<6> A layered body including the resin film according to <5>.

### Advantageous Effects of Invention

According to the present disclosure, a laser marking composition capable of forming a resin film that exhibits excellent visibility and readability when printing one-dimensional or two-dimensional codes, while suppressing the generation of gas during printing, as well as to provide a resin film and a layered body using the laser marking composition, can be provided.

### BRIEF DESCRIPTION OF DRAWINGS

FIG. 1 is a schematic diagram illustrating an example of the cross-sectional structure of a layered body according to one embodiment of the present disclosure.

### MODES FOR CARRYING OUT INVENTION

The embodiments of the present disclosure will be described in detail below. However, the present disclosure is not limited to the following embodiments. In the following embodiments, the constituent elements (including elemental steps and the like) are not essential unless explicitly stated otherwise. The same applies to numerical values and their ranges, which do not limit the present disclosure.

In the present disclosure, the term “step” encompasses not only an independent step, but also encompasses a step that cannot be clearly distinguished from other steps, as long as the intended purpose of the step is achieved.

In the present disclosure, a numerical range expressed using “to” includes numerical values described before and after “to” as a minimum value and a maximum value, respectively.

For numerical value ranges described stepwise in the present disclosure, the upper limit value or the lower limit value of one numerical value range may be replaced with the upper limit value or the lower limit value of another numerical value range described stepwise. The upper limit value or the lower limit value of any numerical value range described in the present disclosure may also be replaced with a value described in Examples.

In the present disclosure, each component may include multiple types of substances corresponding thereto. In a case in which multiple types of substances corresponding to a component of interest are present in a composition, the content ratio or amount of the component means a total content ratio or amount of the multiple types of substances present in the composition, unless otherwise specified.

In the present disclosure, particles corresponding to each component may include multiple types of particles. In a case in which multiple types of particles corresponding to a component in interest are present in the composition, the particle diameter of each component means a value for the mixture of the multiple types of particles in the composition, unless otherwise specified.

In the present disclosure, the term “layer” or “film” encompass not only a case in which a layer or film is formed over an entire region, but also a case in which a layer or film is formed only at a portion of a region when observing the region in which the layer or film is present.

In the present disclosure, the term “layering” refers to stacking layers, in which two or more layers may be joined together, and two or more layers may be detachable from each other.

In the present disclosure, “(meth)acrylic” means at least one of acrylic or methacrylic, and “(meth)acrylate” means at least one of acrylate or methacrylate.

In the present disclosure, the average thickness of a layer or film is defined as the arithmetic mean of thickness measurements taken at five points of the layer or film.

The thickness of a layer or film can be measured using a micrometer or the like. In the present disclosure, in a case in which the thickness of a layer or film can be directly measured, it is measured using a micrometer. In a case of measuring the thickness of a single layer or the total thickness of multiple layers, the measurement may be performed by observing the cross-section of the measurement target using an electron microscope

In the present disclosure, “solid content” refers to components other than the organic solvent in the laser marking composition or a sample solution.

### <Laser Marking Composition>

The laser marking composition of the present disclosure includes at least one (meth)acrylic resin and a metal oxide containing at least one metal selected from the group consisting of bismuth, antimony, molybdenum, copper, iron, nickel, chromium, zirconium, and neodymium, in which a proportion of structural units derived from an acrylic acid alkyl ester containing an alkyl group having 1 to 4 carbon atoms with respect to all structural units of the (meth)acrylic resin is 55% by mass or more.

According to the laser marking composition of the present disclosure, it is capable of forming a resin film that exhibits excellent visibility and readability when printing one-dimensional or two-dimensional codes, while suppressing the generation of gas during printing. Although the reason is not clear, it is presumed as follows.

When comparing structural units derived from an acrylic acid alkyl ester and structural units derived from a methacrylic acid alkyl ester, which may be contained in the (meth)acrylic resin, the difference lies in whether a methyl group is directly bonded to the carbon atoms constituting the main chain of the (meth)acrylic resin. The carbon atom directly bonded to the methyl group becomes a tertiary carbon. In locations where tertiary carbons are present in the main chain of the (meth)acrylic resin, decomposition of the (meth)acrylic resin is likely to occur upon laser irradiation. When the (meth)acrylic resin contains a higher proportion of structural units derived from a methacrylic acid alkyl ester, gas derived from the decomposition products is likely to be generated.

In the present disclosure, because a proportion of structural units derived from an acrylic acid alkyl ester containing an alkyl group having 1 to 4 carbon atoms with respect to all structural units of the (meth)acrylic resin is 55% by mass or more, it is believed that the ratio of tertiary carbons among the carbon atoms constituting the main chain of the (meth)acrylic resin can be maintained relatively low, making it easier to suppress the generation of gas derived from the decomposition products. Furthermore, as the generation of gas is suppressed, blister formation in the resin film composed of the laser marking composition is easier to be suppressed.

In addition, because the number of carbon atoms of an alkyl group contained in Structural units derived from an acrylic acid alkyl ester is 1 to 4, the glass transition temperature of the (meth)acrylic resin is less likely to decrease. Therefore, deformation of the resin film due to heat generated by the reduction of the inorganic oxide under laser irradiation is more easily suppressed.

As a result, it is presumed that visibility and readability when printing one-dimensional or two-dimensional codes are improved.

Hereinafter, each component constituting the laser marking composition of the present disclosure is described.

### ((Meth)acrylic Resin)

The laser marking composition of the present disclosure includes at least one (meth)acrylic resin, in which a proportion of structural units derived from an acrylic acid alkyl ester containing an alkyl group having 1 to 4 carbon atoms with respect to all structural units of the (meth)acrylic resin is 55% by mass or more. The proportion of structural units derived from an acrylic acid alkyl ester containing an alkyl group having 1 to 4 carbon atoms with respect to all structural units of the (meth)acrylic resin is preferably 56% by mass or more, more preferably 60% by mass or more, and still more preferably 90% by mass or more. The proportion of structural units derived from an acrylic acid alkyl ester containing an alkyl group having 1 to 4 carbon atoms with respect to all structural units of the (meth)acrylic resin may be 99% by mass or less. The proportion of structural units derived from an acrylic acid alkyl ester containing an alkyl group having 1 to 4 carbon atoms with respect to all structural units of the (meth)acrylic resin is preferably from 55% by mass to 99% by mass.

In a case in which the laser marking composition of the present disclosure includes one (meth)acrylic resin, as long as the (meth)acrylic resin satisfies the conditions above, it may be a homopolymer consisting of structural units derived from a single (meth)acrylic monomer, or a copolymer consisting of structural units derived from two or more (meth)acrylic monomers.

Further, in a case in which the laser marking composition of the present disclosure includes two or more (meth)acrylic resins, as long as the proportion of structural units derived from an acrylic acid alkyl ester containing an alkyl group having 1 to 4 carbon atoms with respect to all structural units of the two or more (meth)acrylic resins is 55% by mass or more, it is possible to use in combination two or more homopolymers differing in structural units from each other, or to use in combination at least one homopolymer and at least one copolymer, or to use in combination two or more copolymers differing in structural units from each other. Furthermore, in a case in which the laser marking composition of the present disclosure includes two or more (meth)acrylic resins, it is also possible to use, in combination, at least one (meth)acrylic resin in which a proportion of structural units derived from an acrylic acid alkyl ester containing an alkyl group having 1 to 4 carbon atoms with respect to all structural units of the (meth)acrylic resin is 55% by mass or more, together with at least one (meth)acrylic resin in which the aforementioned proportion is less than 55% by mass.

The (meth)acrylic monomer means at least one of acrylic acid, a derivative of acrylic acid such as an acrylic acid alkyl ester, methacrylic acid, or a derivative of methacrylic acid such as a methacrylic acid alkyl ester. The derivative of acrylic acid and methacrylic acid may have a substituent group such as a hydroxy group, an amino group, a carboxy group, a glycidyl group, and the like.

Furthermore, monomers other than (meth)acrylic monomers may also be used for the (meth)acrylic resin.

Specific examples of (meth)acrylic monomers include methyl (meth)acrylate, ethyl (meth)acrylate, n-propyl (meth)acrylate, i-propyl (meth)acrylate, n-butyl (meth)acrylate, i-butyl (meth)acrylate, t-butyl (meth)acrylate, n-hexyl (meth)acrylate, 2-ethylhexyl (meth)acrylate, octyl (meth)acrylate, cyclohexyl (meth)acrylate, phenyl (meth)acrylate, benzyl (methacrylate, phenoxyethyl (meth)acrylate, isobornyl (meth)acrylate, 2-methoxyethyl (meth)acrylate, 2-ethoxyethyl (meth)acrylate, glycidyl (meth)acrylate, and tetrahydrofurfuryl (meth)acrylate.

Specific examples of hydroxy group-containing (meth)acrylic monomers include 2-hydroxyethyl (meth)acrylate, 2-hydroxypropyl (meth)acrylate, 3-hydroxypropyl (methacrylate, 4-hydroxybutyl (meth)acrylate, 3-methyl-3-hydroxybutyl (meth)acrylate, 1,3-dimethyl-3-hydroxybutyl (meth)acrylate, 2,2,4-trimethyl-3-hydroxypentyl (meth)acrylate, 2-ethyl-3-hydroxyhexyl (meth)acrylate, polypropylene glycol mono(meth)acrylate, polyethylene glycol mono(meth)acrylate, poly(ethylene glycol-propylene glycol) mono(meth)acrylate, and pentaerythritol tri(meth)acrylate.

Examples of other monomers that contain a carboxy group include crotonic acid, maleic anhydride, fumaric acid, itaconic acid, glutaconic acid, and citraconic acid. Examples of other monomers that do not contain a carboxy group include vinyl acetate, vinyl ether, acrylonitrile, and styrene.

Preferred examples of the acrylic acid alkyl ester containing an alkyl group having 1 to 4 carbon atoms include ethyl acrylate, methyl acrylate, butyl acrylates such as n-butyl acrylate, i-butyl acrylate, and t-butyl acrylate, and 2-hydroxyethyl acrylate.

In the present disclosure, in an aspect, a total of proportions of structural units derived from ethyl acrylate, structural units derived from methyl acrylate, and structural units derived from 2-hydroxyethyl acrylate with respect to all structural units of the (meth)acrylic resin is preferably 20% by mass or more, more preferably 30% by mass or more, still more preferably 40% by mass or more, and particularly preferably 65% by mass or more. The total of proportions of structural units derived from ethyl acrylate, structural units derived from methyl acrylate, and structural units derived from 2-hydroxyethyl acrylate with respect to all structural units of the (meth)acrylic resin may be 99% by mass or less. The total of proportions of structural units derived from ethyl acrylate, structural units derived from methyl acrylate, and structural units derived from 2-hydroxyethyl acrylate with respect to all structural units of the (meth)acrylic resin is preferably from 20% by mass to 99% by mass.

Ethyl acrylate, methyl acrylate, and 2-hydroxyethyl acrylate exhibit high glass transition temperatures when polymerized as homopolymers, respectively. Therefore, at the portions of structural units derived from ethyl acrylate, structural units derived from methyl acrylate, and structural units derived from 2-hydroxyethyl acrylate in the (meth)acrylic resin, it is believed that the main chain of the (meth)acrylic resin does not move easily even if heat is generated by laser irradiation. As a result, it tends to facilitate more accurate printing.

In the present disclosure, in another aspect, the total of proportions of structural units derived from ethyl acrylate, structural units derived from methyl acrylate, and structural units derived from 2-hydroxyethyl acrylate with respect to all structural units of the (meth)acrylic resin may be 1% by mass or less.

In the present disclosure, a total of proportions of structural units derived from methacrylic acid and structural units derived from a methacrylic acid alkyl ester with respect to all structural units of the (meth)acrylic resin is preferably less than 45% by mass, more preferably 40% by mass or less, still more preferably 35% by mass or less, and particularly preferably 5% by mass or less. The total of proportions of structural units derived from methacrylic acid and structural units derived from a methacrylic acid alkyl ester with respect to all structural units of the (meth)acrylic resin may be 0% by mass. The total of proportions of structural units derived from methacrylic acid and structural units derived from a methacrylic acid alkyl ester with respect to all structural units of the (meth)acrylic resin is preferably 0% by mass or more and less than 45% by mass.

If the total of proportions of structural units derived from methacrylic acid and Structural units derived from a methacrylic acid alkyl ester with respect to all structural units of the (meth)acrylic resin is less than 45% by mass, the generation of gas derived from decomposition products that may be generated by decomposition of the (meth)acrylic resin tends to be more easily suppressed.

A total of proportions of structural units derived from monomers containing a carboxy group in the molecule, such as acrylic acid, methacrylic acid, and other monomers containing a carboxy group, with respect to all structural units of the (meth)acrylic resin is preferably 20% by mass or less, more preferably 10% by mass or less, and still more preferably 5% by mass or less. The total of proportions of structural units derived from monomers containing a carboxy group in the molecule with respect to all structural units of the (meth)acrylic resin may be 0.5% by mass or more. The total of proportions of structural units derived from monomers containing a carboxy group in the molecule with respect to all structural units of the (meth)acrylic resin is preferably from 0.5% by mass to 20% by mass.

When the total of proportions of structural units derived from monomers containing & carboxy group in the molecule with respect to all structural units of the (meth)acrylic resin is 20% by mass or less, it becomes possible to suppress the occurrence of attenuation of absorbance due to the reaction of the metal oxide that has been reduced by laser light irradiation with the carboxy group, and visibility tends to be further improved.

In a case in which the (meth)acrylic resin is a copolymer, the polymerization manner is not particularly limited and may be random copolymerization, alternating copolymerization, block copolymerization, or graft copolymerization.

The weight average molecular weight (Mw) of the (meth)acrylic resin is preferably within a range of from 5,000 to 1,000,000, more preferably within a range of from 10,000 to 800,000, and still more preferably within a range of from 100,000 to 750,000. When the weight average molecular weight (Mw) of the (meth)acrylic resin is 5,000 or more, the resin film tends to be less brittle. Moreover, when the weight average molecular weight (Mw) of the (meth)acrylic resin is 1,000,000 or less, the film-forming properties tend to be excellent.

In a case in which the laser marking composition of the present disclosure includes two or more (meth)acrylic resins in combination, it is preferable that the weight average molecular weight (Mw) of the mixture of the two or more (meth)acrylic resins is within the aforementioned range.

In the present disclosure, the weight average molecular weight (Mw) of the (meth)acrylic resin is a value measured by the following method. Specifically, the measurement is carried out in accordance with (1) to (3) below.

(1) A solution of the (meth)acrylic resin is applied to a release paper, then dried at 100° C. for 1 minute to obtain a film-like (meth)acrylic resin.

(2) The film-like (meth)acrylic resin obtained in (1) above and tetrahydrofuran are used to prepare a sample solution having a solid concentration of 0.2% by mass.

(3) The weight average molecular weight (Mw) of the (meth)acrylic resin is measured by gel permeation chromatography (GPC) under the conditions described below, as a value converted in terms of polystyrene standard.

˜Conditions˜
Measurement apparatus: High-speed GPC (Model: HLC-8220 GPC, TOSOH Corporation)
Detector: Differential refractometer (RI) (incorporated into HLC-8220, TOSOH Corporation)
Column: TSK-GEL GMHXL (TOSOH Corporation), four columns connected in series
Column temperature: 40° C.
Eluent: Tetrahydrofuran
Sample concentration: 0.2% by mass
Injection volume: 100 μL
Flow rate: 0.6 mL/min

In order to suppress deformation of the printed area caused by heat or gas during printing and to allow accurate printing of one-dimensional or two-dimensional codes, the glass transition temperature Tg of the (meth)acrylic resin is preferably −20° C. or higher, more preferably 0° C. or higher, and still more preferably 10° C. or higher. From the viewpoint of good workability of the resin film and resistance to brittleness, the glass transition temperature Tg of the (meth)acrylic resin may be 100° C. or lower. The glass transition temperature Tg of the (meth)acrylic resin is preferably from −20° C. to 100° C.

The glass transition temperature Tg of the (meth)acrylic resin refers to a value obtained as the inflection point of the DSC curve obtained from measurement under the conditions of a nitrogen flow, a measured sample of 10 mg, and a heating rate of 10° C./min using a differential scanning calorimeter (DSC) (for example, EXSTAR 6000, manufactured by Seiko Instruments Inc.). In a case in which two or more inflection points are observed in the DSC curve using a differential scanning calorimeter (DSC), the temperature of the inflection point at the highest temperature is taken as the glass transition temperature Tg of the (meth)acrylic resin.

In a case in which structural units constituting the (meth)acrylic resin are known, the Tg of the (meth)acrylic resin may be a value obtained by converting the absolute temperature (K) determined by the following formula into Celsius temperature (C).

$$\frac{1}{Tg} = \frac{{m}_{1}}{{Tg}_{1}} + \frac{{m}_{2}}{{Tg}_{2}} + … + \frac{{m}_{n}}{{Tg}_{n}}$$

In the formula, Tg₁, Tg₂, . . . and Tgₙ represent glass transition temperatures in terms of absolute temperature (K) of homopolymers of respective monomer 1, monomer 2, . . . and monomer n. Further, m₁, m₂, . . . and mₙ represent mole fractions of the respective monomers.

The “glass transition temperature in terms of absolute temperature (K) of homopolymer” refers to a glass transition temperature in terms of absolute temperature (K) of a homopolymer produced by polymerizing the monomer singly. The glass transition temperature of the homopolymer can be measured by the aforementioned method using a differential scanning calorimeter (DSC).

The “glass transition temperature in terms of Celsius temperature (C) of homopolymer” of typical monomers is as follows: methyl acrylate is 10° C., ethyl acrylate is −22° C., n-butyl acrylate is −54° C., 2-ethylhexyl acrylate is −70° C., 2-hydroxyethyl acrylate is −15° C., 4-hydroxybutyl acrylate is −80° C., t-butyl acrylate is 43° C., vinyl acetate is 32° C., acrylic acid is 106° C., methyl methacrylate is 105° C., and 2-hydroxyethyl methacrylate is 85° C. For example, by using these representative monomers, it is possible to suitably adjust the glass transition temperature described above.

Regarding the “glass transition temperature of homopolymer” of monomers other than those described above, the value described in the Polymer Handbook (4th edition, Wiley-Interscience; hereinafter the same) is adopted. If no value is described in the Polymer Handbook, the glass transition temperature of the homopolymer obtained by the measurement method described above is adopted.

An absolute temperature (K) can be converted to a Celsius temperature (° C.) by subtracting 273 from the absolute temperature (K), and a Celsius temperature (° C.) can be converted to an absolute temperature (K) by adding 273 to the Celsius temperature (° C.).

In a case in which two or more (meth)acrylic resins are used in combination, it is preferable that the glass transition temperature Tg of the (meth)acrylic resin exhibiting the highest glass transition temperature Tg is within the aforementioned range.

The method of producing the (meth)acrylic resin is not particularly limited, and can be produced by polymerizing monomers by methods such as solution polymerization, emulsion polymerization, or suspension polymerization. Notably, when preparing the laser marking composition after producing the (meth)acrylic resin, solution polymerization is preferred because it allows relatively simple and short processing steps.

In general, solution polymerization can be carried out by putting a predetermined organic solvent, monomer, polymerization initiator, and, if necessary, a chain transfer agent into a polymerization vessel, and then heating and reacting the mixture under stirring for several hours, either under a nitrogen stream or at a reflux temperature of the organic solvent. In addition, the weight average molecular weight of the (meth)acrylic resin can be set to a desired value by adjusting the reaction temperature, reaction time, solvent amount, and type or amount of catalyst.

Examples of organic solvents used in the polymerization reaction of the (meth)acrylic resin include aromatic hydrocarbon compounds, aliphatic or cycloaliphatic hydrocarbon compounds, ester compounds, ketone compounds, glycol ether compounds, and alcohol compounds. The organic solvent may be used singly or in combination of two or more thereof.

More specifically, examples of organic solvents used during the polymerization reaction include: aromatic hydrocarbon-based organic solvents, represented by benzene, toluene, ethylbenzene, n-propylbenzene, t-butylbenzene, o-xylene, m-xylene, p-xylene, tetralin, decalin, and aromatic naphtha; aliphatic or cycloaliphatic hydrocarbon-based organic solvents, represented by n-hexane, n-heptane, n-octane, i-octane, n-decane, dipentene, petroleum spirit, petroleum naphtha, and turpentine; ester-based organic solvents, represented by ethyl acetate, n-butyl acetate, n-amyl acetate, 2-hydroxyethyl acetate, 2-butoxyethyl acetate, 3-methoxybutyl acetate, and methyl benzoate; ketone-based organic solvents, represented by acetone, methyl ethyl ketone, methyl i-butyl ketone, isophorone, cyclohexanone, and methyl cyclohexanone; glycol ether-based organic solvents, represented by ethylene glycol monomethyl ether, ethylene glycol monoethyl ether, ethylene glycol monobutyl ether, diethylene glycol monomethyl ether, diethylene glycol monoethyl ether, and diethylene glycol monobutyl ether, and alcohol-based organic solvents, represented by methyl alcohol, ethyl alcohol, n-propyl alcohol, i-propyl alcohol, n-butyl alcohol, i-butyl alcohol, s-butyl alcohol, and t-butyl alcohol.

Examples of polymerization initiators include organic peroxides and azo compounds that can be used in conventional polymerization methods.

The (meth)acrylic resin may be a commercially available product. Examples of commercially available (meth)acrylic resins include KP-1876E (product name: Nissetsu (registered trademark), manufactured by Nippon Carbide Industries Co., Inc.) and H-4002 (manufactured by Negami Chemical Industrial Co., Ltd.).

The content of the (meth)acrylic resin with respect to the solid content of the laser marking composition is preferably from 15% by mass to 99.5% by mass, more preferably from 20% by mass to 99% by mass, and still more preferably from 40% by mass to 98.5% by mass. When the content of the (meth)acrylic resin is from 15% by mass to 99.5% by mass, the heat resistance of the printed portion tends to be improved.

### (Metal Oxide)

The laser marking composition of the present disclosure includes a metal oxide containing at least one metal selected from the group consisting of bismuth, antimony, molybdenum, copper, iron, nickel, chromium, zirconium, and neodymium. The metal oxide serves as a color developing agent.

Among these metals, a bismuth-containing compound is preferable, and bismuth(III) oxide (Bi₂O₃) is more preferable due to its excellent blackness upon color development. In this case, in order to enhance laser printability, a metal oxide with many oxygen vacancies is preferable.

The volume average particle diameter of the metal oxide is not particularly limited, and is preferably from 0.05 μm to 30 μm, more preferably from 0.1 μm to 15 μm, and still more preferably from 0.3 am to 1.5 μm. When the volume average particle diameter of the metal oxide is 0.05 μm or more, the metal oxide absorbs laser light and easily generates heat, so that color development during printing tends to be further improved. On the other hand, when the volume average particle diameter of the metal oxide is 30 μm or less, the dispersibility during film formation tends to be favorable. The volume average particle diameter of the metal oxide refers to a value measured by a laser diffraction/light scattering method.

The specific method of the laser diffraction/light scattering method is as follows: 5 mL of an aqueous dispersion of the metal oxide is collected using a Pastear pipette into a glass cell measuring 5 mm in length, 65 mm in width, and 80 mm in height, and set in a laser diffraction/light scattering particle diameter distribution measurement device (for example, LA-960A (product name), manufactured by Horiba, Ltd.). The concentration of the aqueous dispersion of the metal oxide is adjusted so that the transmittance of laser light (red) is from 80% to 90%, and the results of measurements taken at a measurement temperature of 25° C.±1° C. are then processed by computer to determine the average particle diameter of the metal oxide particles in the aqueous dispersion. The volume average value is used as the average particle diameter value.

The content of the metal oxide with respect to the solid content of the laser marking composition is preferably from 0.2% by mass to 50.0% by mass, more preferably from 0.5% by mass to 25.0% by mass, and still more preferably from 1.0% by mass to 5.0% by mass. When the content of the metal oxide is 0.2% by mass or more, the color develops appropriately during laser marking, and the readability of the laser marked portion tends to be favorable. When the content of the metal oxide is 50.0% by mass or less, dust generation during laser marking can be suppressed, so the readability of the laser marked portion tends to be favorable.

### (Crosslinking Agent)

The laser marking composition of the present disclosure may include a crosslinking agent to improve the strength of the resin film. Examples of crosslinking agents include isocyanate-based crosslinking agents, aluminum chelate-based crosslinking agents, and epoxy-based crosslinking agents. When the laser marking composition includes a crosslinking agent, the (meth)acrylic resin preferably includes structural units derived from a (meth)acrylic monomer containing a hydroxy group or other monomer containing a carboxy group.

In a case in which the laser marking composition includes a crosslinking agent, the content of the crosslinking agent is preferably from 0.1 equivalents to 10 equivalents with respect to the total of the hydroxy groups and the carboxy groups of the (meth)acrylic resin. By setting the content of the crosslinking agent to 0.1 equivalents or more, the action of the molecules can be suppressed and the printing accuracy can be improved. By setting the content of the crosslinking agent to 10 equivalents or less, discoloration of the (meth)acrylic resin can be suppressed. The content of the crosslinking agent is more preferably from 0.3 equivalents to 3.0 equivalents, because it is easy to form a film.

### (White Pigment)

The laser marking composition of the present disclosure may include a white pigment to further improve visibility by increasing the contrast between the black of the printed portion and the white of the non-printed portion.

Various inorganic pigments may be used as the white pigment. Examples of white pigment include titanium oxide (TiO₂), titanium oxide-coated mica, zinc oxide (zine white), basic lead sulfate, zinc sulfide, and antimony oxide. In addition, the white pigment may be barium sulfate, barium carbonate, precipitated calcium carbonate, diatomaceous earth, tale, clay, basic magnesium carbonate, or alumina white. Among them, titanium oxide (TiO₂) is preferable as the white pigment because of its excellent whiteness. In addition, titanium oxide-coated mica may be included because it reflects the transmitted laser light, increasing the efficiency of the reduction reaction of the metal oxide, and as a result, improving the color development.

The volume average particle diameter of the white pigment is not particularly limited, and is preferably from 0.01 μm to 50 μm, more preferably from 0.05 μm to 30 μm, and still more preferably from 0.1 μm to 20 μm. The volume average particle diameter of the white pigment is a value measured by a laser diffraction/light scattering method.

In a case in which the laser marking composition of the present disclosure includes a white pigment, the content of the white pigment with respect to the solid content of the laser marking composition is preferably from 0.01% by mass to 50% by mass, more preferably from 0.1% by mass to 30% by mass, and still more preferably from 1% by mass to 20% by mass. When the content of the white pigment is 0.01% by mass or more, the reduction efficiency of the color developing pigment can be improved, and visibility tends to be further improved. When the content of the white pigment is 50% by mass or less, the decrease in the color development of the metal oxide tends to be prevented.

### (Urethane Resin)

The laser marking composition of the present disclosure may include a urethane resin to improve printability when printing is performed on the surface of a resin film. When the laser marking composition includes a urethane resin, the fixing of the print layer formed on the surface of a resin film is improved.

The type of urethane resin is not particularly limited, and conventionally known urethane resins such as polycarbonate-based urethane resins, polyester-based urethane resins, and polyether-based urethane resins can be used. The urethane resin may be used singly or in combination of two or more thereof.

In a case in which the laser marking composition of the present disclosure includes a urethane resin, the content of the urethane resin with respect to the solid content of the laser marking composition is preferably from 2% by mass to 75% by mass, more preferably from 5% by mass to 20% by mass, and still more preferably from 10% by mass to 15% by mass, from the viewpoint of improving printability. By setting the content of the urethane resin with respect to the solid content of the laser marking composition to 7.5% by mass or less, the laser printability can be maintained. By setting the content of the urethane resin with respect to the solid content of the laser marking composition to 20% by mass or less, suitability for lamination can be maintained.

As the urethane resin, commercially available products can be used.

Examples of commercially available urethane resins include “NE-8836 (polycarbonate-based)”. “NE-8811 (polycarbonate-based)”, and “NE-8850 (polycarbonate-based)” (all manufactured by Dainichiseika Color & Chemicals Co., Ltd.), as well as “Superflex 420 (polycarbonate-based)”, “Superflex 460 (polycarbonate-based)”, and “Superflex 210 (polyester-based)” (all manufactured by Daiichi Kogyo Seiyaku Co., Ltd.), “Pandex T-5275 (polyester-based)”, “Pandex T-9280 (polycarbonate-based)”, “Pandex T-9290 (polycarbonate-based)”, “Pandex T-1190 (polyester-based)”, and “Pandex T-8190 (polyether-based)” (all manufactured by DIC Covestro Polymer Inc.).

### (Filler)

The laser marking composition of the present disclosure may include a filler to improve printability when printing is performed on the surface of a resin film. When the laser marking composition includes a filler, the slipperiness on the surface of a resin film is improved, and the operability when printing is performed on the surface of a resin film is improved, resulting in favorable printability,

As the filler, known fillers such as inorganic particles such as silica particles, resin particles such as acrylic beads and melamine beads can be used. The filler may be used singly or in combination of two or more thereof.

The volume average particle diameter of the filler is not particularly limited, and from the viewpoint of improving slipperiness, it is preferably from 0.5 μm to 25 μm, more preferably from 1 μm to 15 μm, and still more preferably from 2 μm to 10 μm. The volume average particle diameter of the filler is measured by the same method as for the volume average particle diameter of the metal oxide described above.

In a case in which the laser marking composition of the present disclosure includes a filler, the content of the filler with respect to the solid content of the laser marking composition is preferably from 0.2% by mass to 30.0% by mass, more preferably from 0.5% by mass to 20% by mass, and still more preferably from 2% by mass to 10% by mass, from the viewpoint of improving slipperiness.

### (Other Component)

The laser marking composition of the present disclosure may include other resins or various additives to the extent that the visibility, the readability of printed one-dimensional or two-dimensional codes, and the effect of suppressing gas generation during printing are not impaired. Such additives are, for example, dispersants, light stabilizers, heat stabilizers, plasticizers, tackifiers, fillers, and colorants.

### (Organic Solvent)

The laser marking composition of the present disclosure may include an organic solvent to improve coating workability. The organic solvent is not particularly limited as long as it dissolves or disperses each component contained in the laser marking composition. Examples of organic solvents include alcohol-based organic solvents such as methanol, ethanol, n-propanol, isopropanol, and butanol; ketone-based organic solvents such as acetone, methyl ethyl ketone, and methyl isobutyl ketone; ester-based organic solvents such as methyl acetate, ethyl acetate, propyl acetate, and butyl acetate; aliphatic hydrocarbon-based organic solvents such as n-hexane, n-heptane, and n-octane; alicyclic hydrocarbon-based organic solvents such as cyclohexane, methylcyclohexane, ethylcyclohexane, cycloheptane, and cyclooctane; and aromatic hydrocarbon-based organic solvents such as toluene and xylene. The organic solvent may be used singly or in combination of two or more thereof.

In a case in which the laser marking composition of the present disclosure includes an organic solvent, the content of the organic solvent contained in the laser marking composition is preferably from 40% by mass to 90% by mass.

### <Resin Film>

The resin film of the present disclosure is formed by using the laser marking composition of the present disclosure.

The method of producing a resin film using the laser marking composition of the present disclosure is not particularly limited, and the resin film can be formed by a known method using a single layer T-die extruder, a multi-layer T-die extruder, a calendar molding machine, or the like.

Also, the resin film can be formed by applying the laser marking composition of the present disclosure that includes an organic solvent to one side of a substrate film described below and drying it. Examples of such application methods include screen printing, gravure printing, bar coating, knife coating, roll coating, comma coating, blade coating, die costing, and spray coating.

In a case in which the laser marking composition includes a crosslinking agent, the resin film may be cured. Examples of methods for curing the resin film include drying with hot air and heating with a heating device such as an oven or a hot plate.

The average thickness of the resin film is not particularly limited, and may be, for example, from 2 μm to 100 μm.

### <Layered Body>

The layered body of the present disclosure includes the resin film of the present disclosure. The layered body of the present disclosure may be a layered body used for a laser marking label. The layer structure of the layered body is not particularly limited, and may be a layer structure in which a first layer that transmits laser light, a second layer that develops color by laser light, and a third layer having pressure-sensitive adhesiveness that is provided as necessary are layered in this order. Also, the layer structure may be a layer structure in which a first layer that transmits laser light and a second layer having pressure-sensitive adhesiveness that develops color by laser light are layered in this order. In a case in which the layered body has such a structure, it is preferable to use the resin film of the present disclosure as the second layer.

The layered body of the present disclosure includes the resin film of the present disclosure, and thus tends to suppress the generation of gas in the second layer during laser marking. Along with this, the generation of odor is suppressed. In addition, the visibility and readability when printing one-dimensional or two-dimensional codes tend to be improved.

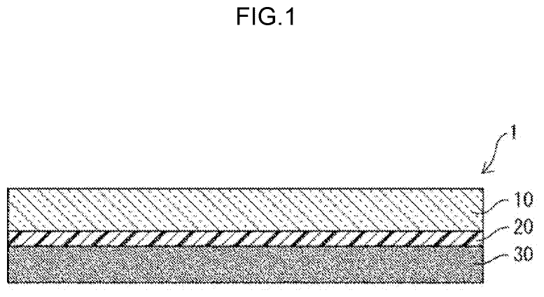

Hereinafter, a case in which the layered body of the present disclosure is applied to a laser marking label having a three-layer structure will be described with reference to FIG. 1. FIG. 1 is a diagram showing a schematic example of a cross-sectional structure of a layered body 1 according to one embodiment of the present disclosure. As shown in FIG. 1, the layered body 1 has a first layer 10, a second layer 20, and a third layer 30, in which the first layer 10, the second layer 20, and the third layer 30 are layered in this order. The second layer 20 is in contact with the first layer 10.

Here, laser marking on the layered body 1 will be described. First, a laser light is irradiated from the first layer 10 side of the layered body 1. The irradiated laser light passes through the first layer 10 and acts on the second layer 20. Since the second layer 20 is formed from the resin film of the present disclosure, the metal oxide develops color at the portion of the second layer 20 irradiated with the laser light, and the resin is carbonized by the heat of the laser light. The colored and carbonized portion of the second layer 20 becomes the printed portion of the laser marking label. The printed portion is an area of the second layer 20 that has turned black. In this way, a type of laser marking label that includes a resin layer containing a metal oxide inside the film and causes the resin layer to develop color by laser irradiation may be particularly referred to as an internal coloring type laser marking label. In the present disclosure, “laser marking” is not limited to the act of writing meaningful information such as letters or symbols on the layered body 1, but the general act of coloring at least a portion of the second layer 20 of the layered body 1 by irradiating it with laser light is referred to as “laser marking”.

Each layer of the layered body will be described below using the layered body 1 according to one embodiment of the present disclosure as an example.

### [First Layer 10]

The first layer 10 is a layer that transmits laser light. In the present disclosure, the first layer 10 may be referred to as a surface layer.

An optically transparent film is used as the first layer 10. In the present disclosure, “optically transparent” means, for example, that the transmittance of laser light is 50% or more and the transmittance of visible light is 80% or more. If the transmittance of visible light of the first layer 10 is sufficiently high, when the layered body 1 after laser marking is viewed in plan from the first layer 10 side, the second layer 20, which is the lower layer, can be sufficiently seen through the first layer 10. The transmittance of laser light and the transmittance of visible light of the substrate film can be measured, for example, using a known spectrophotometer.

The resin used as the material of the substrate film as the first layer 10 may be either a thermoplastic resin or a thermosetting resin. More specifically, the resin used as the material of the substrate film as the first layer 10 is, for example, a (meth)acrylic copolymer, a vinyl butyral resin, a vinyl chloride resin, a fluorine-based resin, a polyester-based resin, a polystyrene resin, and a thermoplastic polyurethane-based resin (TPU). These resins are excellent in transparency, heat resistance, and handling property. These resins may be used singly or in combination of two or more thereof.

Among the resins describe above, polyester-based resins are particularly preferable as the material for the substrate film, since they can sufficiently transmit laser light and have favorable handling property and heat resistance. By forming the substrate film as the first layer 10 from a polyester-based resin, the versatility of the layered body 1 can be increased, and fine laser marking can be achieved.

The polyester-based resin is preferably an aromatic ester-based resin from the viewpoint of suppressing deformation due to heat during laser marking. It is more preferable that the aromatic ester-based resin is a transparent resin from the viewpoint of suppressing deformation due to beat during laser light irradiation.

Examples of aromatic ester-based resins include polyethylene terephthalate (PET), polybutylene terephthalate (PBT), polycyclohexylene dimethylene terephthalate, and polyethylene naphthalate (PEN). Of these, it is more preferable that the aromatic ester-based resin is polyethylene terephthalate from the viewpoint described above.

The thickness of the first layer 10 is not particularly limited, and a larger thickness is more preferable from the viewpoint of chemical resistance and abrasion resistance. The upper limit of the thickness of the first layer 10 may be appropriately set from the viewpoint of workability and cost. For example, from the viewpoint of improving workability (e.g., handling property) when affixing the layered body 1 to an adherend, the thickness of the first layer 10 is preferably in a range of from 10 μm to 200 μm.

In addition, the resin used as the material of the substrate film as the first layer 10 may include various additives to the extent that the print readability and adhesion are not impaired. Such additives are, for example, dispersants, light stabilizers, heat stabilizers, plasticizers, fillers, and colorants.

In addition, the surface of the first layer 10 at the side having the second layer 20 may be subjected to corona treatment or provided with an easy-adhesion layer.

### [Second Layer 20]

The second layer 20 develops color by laser light. In the present disclosure, the second layer 20 may be referred to as a color developing layer 20. The second layer 20 is composed of the resin film of the present disclosure.

The thickness of the second layer 20 is not particularly limited, and is preferably from 2 μm to 100 μm, more preferably from 10 μm to 70 μm, and still more preferably from 15 μm to 50 μm. When the thickness of the second layer 20 is 2 μm or more, the printing can be sufficiently recognized. Furthermore, when the thickness of the second layer 20 is 15 am or more, the penetration resistance against laser light and printability are improved. Furthermore, when the thickness of the second layer 20 is 100 μm or less, the productivity of the second layer 20 is improved.

### [Third Layer 30]

The third layer 30 has pressure-sensitive adhesiveness. In the present disclosure, the third layer 30 may be referred to as a pressure adhesive layer 30.

Any pressure-sensitive adhesive that is capable of adhering to an adherend such as a resin plate, a metal plate, or a glass plate, and can be peeled from the adherend can be used for the third layer 30. Specifically, the adhesive strength of the pressure sensitive adhesive used for the third layer 30 is preferably from 0.1 N/25 mm to 40 N/25 mm, and more preferably from 0.3 N/25 mm to 30/25 mm. When the adhesive strength of the pressure-sensitive adhesive is 0.1 N/25 mm or more, adhesion to an adherend is obtained. When the adhesive strength of the pressure-sensitive adhesive is 40 N/25 mm or less, the peelability of the pressure-sensitive adhesive is favorable. The adhesive strength of the pressure-sensitive adhesive refers to a value measured by attaching a 10 mm wide layered body to an aluminum plate with a load of 2 kg, leaving it at 23° C. for 24 hours, and then peeling the layered body from the aluminum plate at a peel angle of 180°, a peel speed of 300 mm/min, and a measurement temperature of 23° C.

The third layer 30 consists of a resin composition. Examples of resin compositions used for the third layer 30 include (meth)acrylic-based pressure-sensitive adhesives, silicone-based pressure-sensitive adhesives, and synthetic rubber-based pressure-sensitive adhesives, and from the viewpoint of increasing the adhesion between the second layer 20 and the third layer 30, a (meth)acrylic-based pressure-sensitive adhesive is more preferable.

The thickness of the third layer 30 is not particularly limited, and is preferably in a range of from 5 μm to 100 μm. When the thickness of the third layer 30 is in the aforementioned range, the workability (e.g., handling property) when affixing the layered body 1 to an adherend is improved.

The resin composition used for the third layer 30 may include various additives to the extent that the print readability and adhesion are not impaired. Examples of such additives include dispersants, light stabilizers, heat stabilizers, plasticizers, tackifiers, fillers, and colorants.

The colorant used in the third layer 30 is preferably a metal oxide-based pigment. By using a metal oxide-based pigment, the concealment of the base tends to be improved and the penetration of the laser tends to be reduced. Furthermore, the laser light is reflected by the metal oxide-based pigment, which increases the efficiency of the reduction reaction of the metal oxide present in the second layer 20, resulting in that the color development tends to be improved. Examples of metal oxide-based pigments include metal oxides containing at least one metal selected from the group consisting of titanium, molybdenum, copper, iron, nickel, chromium, zirconium, and neodymium, but are not limited to these.

### [Method of Laser Marking on Layered Body 1]

Laser marking on the layered body 1 can be performed by irradiating the layered body 1 with laser light from the first layer 10 side.

The laser used for laser marking can be, for example, a near-infrared laser with a wavelength of about 1000 nm; YVO₄ laser, YAG laser, or fiber laser. A UV laser with a wavelength of from 300 nm to 400 am can also be used.

Laser marking on the layered body 1 is usually performed before attaching the layered body 1 to an adherend. It is also possible to perform laser marking after attaching the layered body 1 to an adherend, but in this case, it is preferable that the layered body 1 has sufficient penetration resistance so that the adherend to which the layered body 1 is attached is not damaged by laser irradiation.

### [Method of Producing Layered Body 1]

The layered body 1 can be produced by layering the first layer 10, the second layer 20, and the third layer 30 in this order. For example, the layered body 1 can be produced by a production method including at least a second layer forming step of forming the second layer 20 at one side of the first layer 10, and a third layer forming step of forming the third layer 30 at the side of the second layer 20 after the second layer forming step that is not in contact with the first layer 10.

The second layer forming step may be a step of applying a laser marking composition used for the second layer 20 to one side of a substrate film as the first layer 10, and curing the laser marking composition as necessary to form the second layer 20. The method of forming the second layer 20 may be the same as the production method of the resin film of the present disclosure described above.

The third layer forming step may be a step of applying a resin composition used for the third layer 30 to the surface of the second layer 20 after the second layer forming step at a side that is not in contact with the first layer 10, and curing the resin composition to form the third layer 30. In another embodiment, the third layer forming step may be a step of applying a resin composition used for the third layer 30, curing the resin composition to form the third layer 30, and then affixing the third layer 30 to the surface of the second layer 20 after the second layer forming step at a side that is not in contact with the first layer 10. The resin composition used for the third layer 30 is as described in the section “Third layer 30”. In the method of producing the layered body 1, the method of applying a resin composition used for the third layer 30 and the method of curing the resin composition used for the third layer 30 can also be performed by the known application method and curing method as described above.

If necessary, the method of producing the layered body 1 may further include a first layer forming step of forming the first layer 10 before the second layer forming step.

### OTHER EMBODIMENT

The layered body of the present disclosure is not limited to the layered body 1 applied to a laser marking label having a three-layer structure of the first layer, the second layer, and the third layer. The layered body of the present disclosure may be a layered body consisting of the second layer and the third layer but not having the first layer, a layered body having the second layer, the third layer, and other layers but not having the first layer, or a layered body having the first layer, the second layer, the third layer, and other layers.

Examples of other layers include a color layer, a print layer, and an easy-adhesion layer.

The color layer is provided, for example, between the second layer and the third layer, and is a layer that imparts color, pattern, and the like to the entire layered body Provision of a color layer improves the design of the layered body.

Examples of the color layer include a layer containing a resin and a colorant. The resin contained in the color layer is not particularly limited, and examples thereof include the same resin as that used in the first layer. The colorant contained in the color layer is not particularly limited, and examples thereof include a pigment and a dye.

The thickness of the color layer is not particularly limited, and can be in a range of from 1 μm to 50 μm, for example.

The color layer may be formed by applying a resin composition for forming a color layer to the surface of the second layer at a side of the third layer, or the color layer may be formed separately and then affixed to the surface of the second layer at a side of the third layer. In a case in which the color layer is affixed to the surface of the second layer, a pressure-sensitive adhesive layer may be further provided between the color layer and the second layer.

The print layer is, for example, a layer provided between the second layer and the third layer, and formed by a printer. Specifically, for example, the print layer is formed by applying a resin composition that includes a resin, a colorant, a solvent, etc. to the surface of a layer adjacent to the print layer in the shape of a desired pattern, letter, etc., and then subjecting to a process such as drying and curing, as necessary. Provision of a print layer improves the design of the layered body. The print layer may be provided on only a portion of the layered body in the surface direction, or on the entire surface.

Examples of printing methods include inkjet printer printing, screen printing, gravure printing, and flexographic printing.

The print layer is formed, for example, by printing on the surface of the second layer at a side of the third layer.

In a case in which the layered body includes a color layer, the print layer may be provided, for example, between the second layer and the color layer. The print layer may be formed by printing on the surface of the second layer at a side of the color layer, or by printing on the surface of the color layer at a side of the second layer.

In a case in which the print layer is formed by printing on the surface of the second layer, it is preferable that the laser marking composition used to form the second layer contains at least one of the urethane resin or filler described above.

### EXAMPLES

The present disclosure will be described in more detail below based on Examples, but the present invention is not limited to these examples.

### Polymerization Example 1

70.0 parts by mass of ethyl acetate [organic solvent] was put into a reaction vessel of a reaction apparatus equipped with a stirrer, a reflux condenser, a successive dropping device, and a thermometer.

In a separate vessel, 100.0 parts by mass of a monomer mixture consisting of 65.0 parts by mass of ethyl acrylate [EA; acrylic acid alkyl ester monomer containing an alkyl group having 1 to 4 carbon atoms], 21.0 parts by mass of methyl methacrylate [MMA; methacrylic acid alkyl ester monomer), and 14.0 parts by mass of 2-hydroxyethyl methacrylate [2HEMA; methacrylic acid alkyl ester monomer having a hydroxy group] was prepared. 20.0% by mass of this prepared monomer mixture was put into the reaction vessel described above, and then heated and refluxed at a reflux temperature for 10 minutes.

Next, under the reflux temperature condition, the remaining 80.0% by mass of the monomer mixture, 50.0 parts by mass of ethyl acetate, and 0.026 parts by mass of 2,2′-azobisisobutyronitrile [AIBN; polymerization initiator] were successively dropped into the reaction vessel for a period of 120 minutes, and after the dropping was completed, the reaction was allowed to proceed for an additional 150 minutes to complete the reaction. The solution after the reaction was completed was diluted with ethyl acetate to a solid concentration of 35.0% by mass, to obtain a (meth)acrylic resin solution of Polymerization Example 1.

The “solid concentration” as used herein means a mass proportion of the (meth)acrylic resin with respect to the (meth)acrylic resin solution.

Table 1 also describes the weight average molecular weight (Mw) and the glass transition temperature (Tg) of the (meth)acrylic resin of Polymerization Example 1, as well as the proportion (A, % by mass) of structural units derived from an acrylic acid alkyl ester containing an alkyl group having 1 to 4 carbon atoms, the total of proportions (A-1, % by mass) of structural units derived from ethyl acrylate, structural units derived from methyl acrylate, and structural units derived from 2-hydroxyethyl acrylate, and the total of proportions (B, % by mass) of structural units derived from a methacrylic acid alkyl ester, each with respect to all structural units of the (meth)acrylic resin. The weight average molecular weight of the (meth)acrylic resin solution is a value measured by the method described above. The glass transition temperature Tg of the (meth)acrylic resin is a value obtained by converting the absolute temperature (K) calculated by the above-described formula into Celsius temperature (° C.).

### Synthesis of Polymerization Example 2 to Polymer 10

The (meth)acrylic resin solutions of Polymerization Examples 2 to 10 were obtained in the same manner as in Polymerization Example 1, except that the monomers described in Table 1 were used instead of those of Polymerization Example 1. In Table 1, MA represents methyl acrylate (acrylic acid alkyl ester monomer containing an alkyl group having 1 to 4 carbon atoms), BA represents butyl acrylate (acrylic acid alkyl ester monomer containing an alkyl group having 1 to 4 carbon atoms), 2HEA represents 2-hydroxyethyl acrylate (acrylic acid alkyl ester monomer containing an alkyl group having 1 to 4 carbon atoms and a hydroxy group), nBMA represents n-butyl methacrylate (methacrylic acid alkyl ester monomer), 2EHA represents 2-ethylhexyl acrylate (acrylic acid alkyl ester monomer), and AA represents acrylic acid.

TABLE 1

| | | | | | | | | | | (A) | (A-1) | (B) | | |
|---|---|---|---|---|---|---|---|---|---|---|---|---|---|---|
| Polymerization | (Meth)acrylic resin [parts by mass] | | | | | | | | | [% by | [% by | [% by | Tg | |
| Example No. | EA | MA | BA | 2HEA | MMA | nBMA | 2HEMA | 2EHA | AA | mass] | mass] | mass] | (° C.) | Mw |
| Polymerization | 65.0 | | | | 21.0 | | 14.0 | | | 65.0 | 65.0 | 35.0 | 9.8 | 120,000 |
| Example 1 | | | | | | | | | | | | | | |
| Polymerization | | 30.0 | 69.0 | | | | | | 1.0 | 99.0 | 30.0 | 0.0 | −37.0 | 700,000 |
| Example 2 | | | | | | | | | | | | | | |
| Polymerization | 23.8 | | 70.2 | | | | | | 6.0 | 94.0 | 23.8 | 0.0 | −41.1 | 500,000 |
| Example 3 | | | | | | | | | | | | | | |
| Polymerization | | | 90.0 | | | | | | 10.0 | 90.0 | 0.0 | 0.0 | −44.3 | 650,000 |
| Example 4 | | | | | | | | | | | | | | |
| Polymerization | | | 97.0 | | | | | | 3.0 | 97.0 | 0.0 | 0.0 | −51.2 | 600,000 |
| Example 5 | | | | | | | | | | | | | | |
| Polymerization | | 52.0 | | | | | | 47.0 | 1.0 | 52.0 | 52.0 | 0.0 | −33.7 | 650,000 |
| Example 6 | | | | | | | | | | | | | | |
| Polymerization | | | 5.0 | 12.5 | 81.5 | | | | 1.0 | 17.5 | 12.5 | 81.5 | 72.4 | 10,000 |
| Example 7 | | | | | | | | | | | | | | |
| Polymerization | | | 13.5 | | 40.0 | 33.0 | 13.0 | | 0.5 | 13.5 | 0.0 | 86.0 | 41.7 | 10,000 |
| Example 8 | | | | | | | | | | | | | | |
| Polymerization | | 50.0 | 49.0 | | | | | | 1.0 | 99.0 | 50.0 | 0.0 | −24.9 | 700,000 |
| Example 9 | | | | | | | | | | | | | | |
| Polymerization | | 97.0 | | | | | | | 3.0 | 97.0 | 97.0 | 0.0 | 12.2 | 110,000 |
| Example 10 | | | | | | | | | | | | | | |

### Examples 1 to 16 and Comparative Examples 1 to 3

The components shown in Table 2 were mixed at the ratios (parts by mass) shown in Table 2, and adjusted with ethyl acetate to a solid concentration of 20% by mass to obtain laser marking compositions of Examples 1 to 16 and Comparative Examples 1 to 3. Table 2 also shows the proportion (A, % by mass) of structural units derived from an acrylic acid alkyl ester containing an alkyl group having 1 to 4 carbon atoms, the total of proportions (A-1. % by mass) of structural units derived from ethyl acrylate, structural units derived from methyl acrylate, and structural units derived from 2-hydroxyethyl acrylate, and the total of proportions (B, % by mass) of structural units derived from a methacrylic acid alkyl ester, each with respect to all structural units of the (meth)acrylic resin.

In Table 2, a solid content of the (meth)acrylic resin is indicated for Polymerization Examples 1 to 10. In Table 2, a solid content of the titanium oxide pigment is indicated for the white pigment.

Details of each component shown in Table 2 are as follows.
Color developing pigment 1: Bismuth oxide-based color developing pigment (42-970A, TOMATEC Corporation)
Color developing pigment 2: Iron oxide-based color developing pigment (NX-512 Yellow, pigment manufactured by Dainichiseika Color & Chemicals Co., Ltd., iron oxide 56% by mass)
White pigment: NBK-967 White (titanium oxide pigment content 58.5% by mass, cellulose acetate butyrate 7% by mass, methyl isobutyl ketone, Nikko Bix Co., Ltd.)

Both sides of a PET film (surface layer) with a thickness of 50 μm were subjected to corona treatment. The laser marking composition was applied to one side of the PET film so that the film thickness after drying was the thickness shown in Table 2, and then dried at 70° C. for 3 minutes and at 150° C. for 3 minutes to form a laser marking layer (color developing layer).

100 parts by mass of an acrylic resin PE-121 (Nippon Carbide Industries Co., Ltd.) was mixed with 0.53 parts by mass of a crosslinking agent CK-401 (Nippon Carbide Industries Co., Ltd.), mixed with ethyl acetate to achieve an appropriate viscosity, and then applied to a release-treated PET (7E0010GT, manufactured by Fujimori Kogyo Co., Ltd.) to a thickness of 20 μm, and heated at 100° C. for 1 minute to form a pressure-sensitive adhesive layer on the release-treated PET. The pressure-sensitive adhesive side of this pressure-sensitive adhesive layer was affixed to the laser marking layer to form a layered body for laser marking of respective Example and Comparative Example.

The following evaluations were carried out on the obtained layered body for laser marking.

### [Printability]

Using a FAYb laser marker LP-Z130 (manufactured by Panasonic Corporation), the surface layer of the layered body for laser marking was irradiated with laser light under the conditions of an output (printing intensity) of 25%, a pulse cycle of 50 Hz, a line width of 0.07 mm, and 2000 mm/sec to print a 15 mm square of solid fill patter. The layered body for laser marking was then attached to a glass plate, and a concealment test paper specified in JIS K5600-4-1:1999 was placed on the back of the glass side to measure the color difference between the layered body itself and the printed area with a colorimeter (product name “Spectrophotometer CM-3600A”, manufactured by Konica Minolta, Inc.), and ΔE*ab was calculated. The results are shown in Table 2. If ΔE*ab is 5 or more, there is no problem in practical use. The larger ΔE*ab, the better the visibility.

### [Two-Dimensional Codes Readability]

Laser light was irradiated with the surface layer of the layered body using a FAYb laser marker LP-Z130 (manufactured by Panasonic Corporation) under the conditions of an output (printing intensity) of 20%, 30%, and 50%, a pulse cycle of 50 Hz, a line width of 0.07 mm, and 2000 mm/sec to print two-dimensional codes of 4 mm square and 8 mm square. After that, a reading test was carried out 100 times using a code reader (manufactured by Keyence Corporation, product name SR-H60W) and evaluated according to the following criteria. If the evaluation is B or higher, there is no problem in practical use.

S: The reading success rate for 8 mm square is 80% or higher.

A: The reading success rate for 8 mm square is 50% or higher.

B: The reading success rate for 4 mm square is 90%.

C: The reading success rate for 4 mm square is 50% or higher.

D: The reading success rate for 4 mm squares is less than 50%.

### [Blister]

Laser light was irradiated with the surface layer of the layered body using a FAYb laser marker LP-Z130 (manufactured by Panasonic Corporation) under the conditions of an output (printing intensity) of 20%, 30%, and 50%, a pulse cycle of 50 Hz, a line width of 0.07 mm, and 2000 mm/sec to print two-dimensional codes of 4 mm square and 8 mm square. Whether or not blisters occurred between the release-treated PET and the pressure-sensitive adhesive layer was observed visually and by touch, and evaluated according to the following criteria. If the evaluation is B or higher, there is no problem in practical use.

It can be said that the less blisters there are, the more gas generation during printing is suppressed.

A: No blister occurs even at printing intensity of 50%.

B: Blisters occur at printing intensity of 50%.

C: Blisters occur regardless of printing intensity.

TABLE 2

| | Example 1 | Example 2 | Example 3 | Example 4 | Example 5 | Example 6 | Example 7 | Example 8 |
|---|---|---|---|---|---|---|---|---|
| Polymerization | 100.00 | | | | | | 100.00 | |
| Example 1 | | | | | | | | |
| Polymerization | | 100.00 | | | | | | |
| Example 2 | | | | | | | | |
| Polymerization | | | 100.00 | | | | | |
| Example 3 | | | | | | | | |
| Polymerization | | | | 100.00 | | 100.00 | | 100.00 |
| Example 4 | | | | | | | | |
| Polymerization | | | | | 100.00 | | | |
| Example 5 | | | | | | | | |
| Polymerization | | | | | | | | |
| Example 6 | | | | | | | | |
| Polymerization | | | | | | | | |
| Example 7 | | | | | | | | |
| Polymerization | | | | | | | | |
| Example 8 | | | | | | | | |
| Polymerization | | | | | | | | |
| Example 9 | | | | | | | | |
| Polymerization | | | | | | | | |
| Example 10 | | | | | | | | |
| (A) | 65.00 | 99.00 | 94.00 | 90.00 | 97.00 | 90.00 | 65.00 | 90.00 |
| (A-1) | 65.00 | 30.00 | 23.80 | 0.00 | 0.00 | 0.00 | 65.00 | 0.00 |
| (B) | 35.00 | 0.00 | 0.00 | 0.00 | 0.00 | 0.00 | 35.00 | 0.00 |
| Color developing | 1.60 | 1.60 | 1.60 | 1.60 | 1.60 | 1.60 | 1.60 | 1.60 |
| pigment 1 | | | | | | | | |
| Color developing | | | | | | | | |
| pigment 2 | | | | | | | | |
| White pigment | | | | | | 5.00 | | |
| Film thickness | 10 | 10 | 10 | 10 | 10 | 10 | 20 | 20 |
| [μm] | | | | | | | | |
| Printability | 27.21 | 14.09 | 10.29 | 16.56 | 22.44 | 10.82 | 27.79 | 19.96 |
| (ΔE*ab) | | | | | | | | |
| 2D codes | S | A | B | B | B | B | S | B |
| readability | | | | | | | | |
| Blister | B | A | A | A | A | A | B | A |

| | Example 9 | Example 10 | Example 11 | Example 12 | Example 13 | Example 14 | Example 15 | Example 16 |
|---|---|---|---|---|---|---|---|---|
| Polymerization | | | | 50.00 | | | | |
| Example 1 | | | | | | | | |
| Polymerization | | | | | 100.00 | 100.00 | | |
| Example 2 | | | | | | | | |
| Polymerization | | | 50.00 | 25.00 | | | | |
| Example 3 | | | | | | | | |
| Polymerization | | | | | | | 100.00 | |
| Example 4 | | | | | | | | |
| Polymerization | 100.00 | | | | | | | |
| Example 5 | | | | | | | | |
| Polymerization | | | | | | | | |
| Example 6 | | | | | | | | |
| Polymerization | | | 50.00 | 25.00 | | | | |
| Example 7 | | | | | | | | |
| Polymerization | | | | | | | | |
| Example 8 | | | | | | | | |
| Polymerization | | 100.00 | | | | | | |
| Example 9 | | | | | | | | |
| Polymerization | | | | | | | | 100.00 |
| Example 10 | | | | | | | | |
| (A) | 97.00 | 99.00 | 55.75 | 60.38 | 99.00 | 99.00 | 90.00 | 97.00 |
| (A-1) | 0.00 | 50.00 | 18.15 | 41.58 | 30.00 | 30.00 | 0.00 | 97.00 |
| (B) | 0.00 | 0.00 | 40.75 | 37.88 | 0.00 | 0.00 | 0.00 | 0.00 |
| Color developing | 1.60 | 1.60 | 1.60 | 1.60 | 0.50 | 2.50 | | 1.60 |
| pigment 1 | | | | | | | | |
| Color developing | | | | | | | 50.00 | |
| pigment 2 | | | | | | | | |
| White pigment | | | | | | | | |
| Film thickness | 20 | 10 | 35 | 35 | 40 | 30 | 50 | 20 |
| [μm] | | | | | | | | |
| Printability | 26.79 | 16.44 | 21.69 | 27.85 | 10.10 | 14.18 | 6.62 | 41.28 |
| (ΔE*ab) | | | | | | | | |
| 2D codes | B | S | S | S | A | A | B | S |
| readability | | | | | | | | |
| Blister | A | A | B | B | A | A | B | B |

| | Comparative | Comparative | Comparative |
|---|---|---|---|
| | Example 1 | Example 2 | Example 3 |
| Polymerization | | | |
| Example 1 | | | |
| Polymerization | | | |
| Example 2 | | | |
| Polymerization | | | |
| Example 3 | | | |
| Polymerization | | | |
| Example 4 | | | |
| Polymerization | | | |
| Example 5 | | | |
| Polymerization | 100.00 | | |
| Example 6 | | | |
| Polymerization | | 100.00 | |
| Example 7 | | | |
| Polymerization | | | 100.00 |
| Example 8 | | | |
| Polymerization | | | |
| Example 9 | | | |
| Polymerization | | | |
| Example 10 | | | |
| (A) | 52.00 | 17.50 | 13.50 |
| (A-1) | 52.00 | 12.50 | 0.00 |
| (B) | 0.00 | 81.50 | 86.00 |
| Color developing | 1.60 | 1.60 | 1.60 |
| pigment 1 | | | |
| Color developing | | | |
| pigment 2 | | | |
| White pigment | | | |
| Film thickness | 10 | 10 | 10 |
| [μm] | | | |
| Printability | 2.97 | 8.93 | 3.67 |
| (ΔE*ab) | | | |
| 2D codes | A | B | S |
| readability | | | |
| Blister | A | C | C |

From the evaluation results shown in Table 2, it can be seen that the layered body for laser marking having a color developing layer (resin film) obtained from the laser marking composition of Examples achieved a high level of visibility, readability, and suppression of gas generation, compared to the layered body for laser marking having a color developing layer (resin film) obtained from the laser marking composition of Comparative Examples.

The disclosure of Japanese Patent Application No. 2022-159099, filed Sep. 30, 2022, is incorporated herein by reference in its entirety.

All publications, patent applications, and technical standards mentioned in this specification are herein incorporated by reference to the same extent as if each individual publication, patent application, or technical standard was specifically and individually indicated to be incorporated by reference.

### EXPLANATION OF REFERENCE SIGNS

1 Layered body
10 First layer (surface layer)
20 Second layer (color developing layer)
30 Third layer (pressure-sensitive adhesive layer)

1. A laser marking composition comprising at least one (meth)acrylic resin and a metal oxide containing at least one metal selected from the group consisting of bismuth, antimony, molybdenum, copper, iron, nickel, chromium, zirconium, and neodymium,
wherein a proportion of structural units derived from an acrylic acid alkyl ester containing an alkyl group having 1 to 4 carbon atoms with respect to all structural units of the (meth)acrylic resin is 55% by mass or more.

2. The laser marking composition according to claim 1, wherein a total of proportions of structural units derived from methacrylic acid and structural units derived from a methacrylic acid alkyl ester with respect to all structural units of the (meth)acrylic resin is less than 45% by mass.

3. The laser marking composition according to claim 1, wherein a total of proportions of structural units derived from ethyl acrylate, structural units derived from methyl acrylate, and structural units derived from 2-hydroxyethyl acrylate with respect to all structural units of the (meth)acrylic resin is 20% by mass or more.

4. The laser marking composition according to claim 1, wherein the metal oxide comprises a bismuth-containing compound.

5. A resin film formed by using the laser marking composition according to claim 1.

6. A layered body comprising the resin film according to claim 5.
